(19) United States
(12) Patent Application Publication
(10) Pub. No.: US 2007/0279789 A1
(43) Pub. Date: Dec. 6, 2007

(54) Track based multiple sector error recovery

(75) Inventors: Theodore J. Smith, Layton, UT (US); Sterling Todd Howard, Riverdale, UT (US)

Correspondence Address: PROCOPIO, CORY, HARGREAVES & SAVITCH LLP, 530 B STREET, SUITE 2100, SAN DIEGO, CA, 92101, US

(73) Assignee: Iomega Corporation

(21) Appl. No.: 11/447,497

(22) Filed: Jun. 5, 2006

(51) Int. Cl. G11B 5/09

(52) U.S. Cl. 360/53

(57) ABSTRACT

Error correction in a disk drive is performed by identifying all errors in multiple sectors of a single track during a single read operation. As the data from the track is moved to a buffer, the disk drive records the location of the errors without stopping the read operation. Following the read operation, error recovery is performed on all errors identified in the track. If further error recovery is needed on the track, a subsequent read operation may then be performed.

### TECHNICAL FIELD

This invention relates to computer storage products, and more particularly to sector based error recovery of disk drives.

### BACKGROUND

A disk drive is a data storage device that stores data in concentric tracks on a disk. Data is written to or read from the disk by spinning the disk about a central axis while positioning a transducer near a target track of the disk. During a read operation, data is transferred from the target track to an attached host through the transducer. During a write operation, data is transferred in the opposite direction.

Typically, the head-disk assembly has a disk with a recording surface rotated at a constant speed by a spindle motor assembly and a head stack assembly positionably controlled by a closed loop servo system. The head stack assembly supports a read/write head that writes data to and reads data from the recording surface. Disk drives using a magneto resistive read/write head typically use an inductive element, or writer, to write data to the information tracks and a magnetoresistive element, or reader, to read data from the information tracks during drive operations.

Disk drives may contain errors that hinder disk drive performance. Errors are non-permanent in nature and may only occur during a single revolution of the disc. For instance, when accessing a file pursuant to a read command, an error may occur thereby rendering a particular sector of the file is inaccessible. However, that sector may be accessible to subsequent read commands or upon subsequent revolutions initiated during a read error recovery procedure of the present read command.

Conventional methods employing read error recovery procedures immediately suspend the read operation when an error is encountered. Following a complete revolution of the disc, the sector having the error is positioned under the read/write head and the disk drive retries the read operation at the previously defective sector. Again, if the error is still present, conventional methods repeat the suspension and retry process until the read operation is successful. Once recovery is successful, the read command is executed until either another error is encountered or the end of the file being read is reached.

As the potential for multiple errors on a track increases, the use of the current error recovery technique becomes time consuming. As it stands today, the layout of the disk is track based (as opposed to spiral formats) which creates natural transfer discontinuities at track boundaries. The current architecture stops the transfer when an uncorrectable error is encountered. This means rereads of erroneous sectors (during recovery attempts) incur a time penalty of at least one revolution of the disk since it will take at least that long to get the heads back over the error location to retry it. Thus, if multiple errors are encountered on a track, multiple revolutions of the disk are administered to recover the data from the defective sector.

What is needed is a disk drive that speeds up the time it takes for erroneous sectors to be corrected. It is desirable to never stop attempting to move data until all sectors on a track have been read, regardless of whether errors are encountered during the read operation.

### SUMMARY

Error correction in a disk drive is performed by identifying all errors in multiple sectors of a single track during a single read operation. As the data from the track is moved to a buffer, the disk drive records the location of the errors without stopping the read operation. Following the read operation, error recovery is performed on all errors identified in the track. If further error recovery is needed on the track, a subsequent read operation may then be performed.

### DESCRIPTION OF DRAWINGS

These and other features and advantages of the invention will become more apparent upon reading the following detailed description and upon reference to the accompanying drawings.

FIG. 1 is a diagrammatic view of an apparatus which is an information storage system that embodies aspects of the present invention.

FIG. 2 is a flowchart illustrating a process for compensating for sector errors as performed in the prior art.

FIG. 3 is a flowchart illustrating a process for compensating for multiple sector errors as according to one embodiment of the present invention.

### DETAILED DESCRIPTION

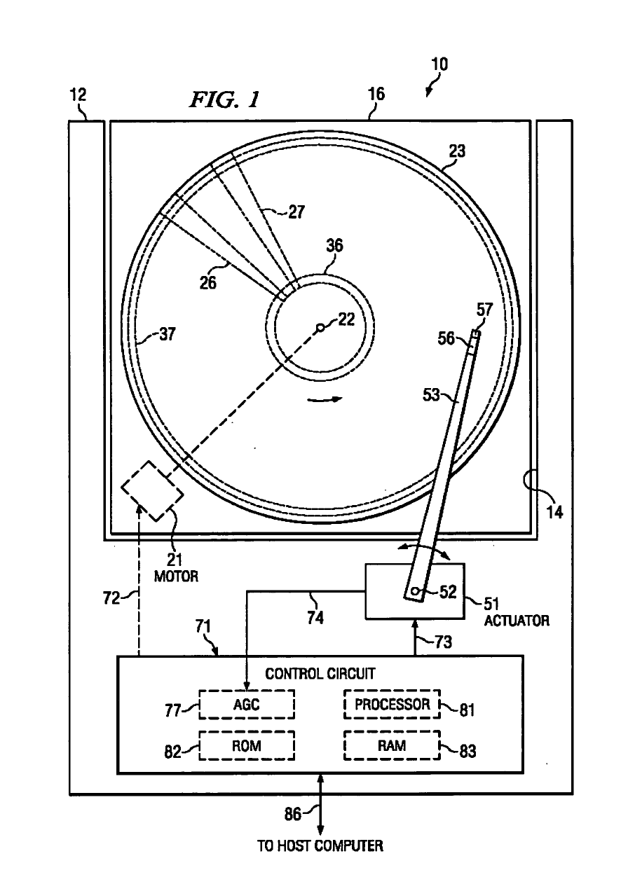

FIG. 1 is a diagrammatic view of an apparatus which is an information storage system 10, and which embodies aspects of the present invention. The system 10 includes a receiving unit or drive 12 which has a recess 14, and includes a cartridge 16 which can be removably inserted into the recess 14.

The cartridge 16 has a housing, and has within the housing a motor 21 with a rotatable shaft 22. A disk 23 is fixedly mounted on the shaft 22 for rotation therewith. The side of the disk 23 which is visible in FIG. 1 is coated with a magnetic material of a known type, and serves as an information storage medium. This disk surface is conceptually divided into a plurality of concentric data tracks. In the disclosed embodiment, there are about 50,000 data tracks, not all of which are available for use in storing user data.

The disk surface is also conceptually configured to have a plurality of circumferentially spaced sectors, two of which are shown diagrammatically at 26 and 27. These sectors are sometimes referred to as servo wedges. The portions of the data tracks which fall within these sectors or servo wedges are not used to store data. Data is stored in the portions of the data tracks which are located between the servo wedges. The servo wedges are used to store servo information of a type which is known in the art. The servo information in the servo wedges conceptually defines a plurality of concentric servo tracks, which have a smaller width or pitch than the data tracks. In the disclosed embodiment, each servo track has a pitch or width that is approximately two-thirds of the pitch or width of a data track. Consequently, the disclosed disk 23 has about 73,000 servo tracks. The servo tracks effectively define the positions of the data tracks, in-a manner known in the art.

Data tracks are arranged in a concentric manner ranging from the radially innermost tracks 36 to the radially outermost tracks 37. User data is stored in the many data tracks that are disposed from the innermost tracks 36 to the outermost tracks 37 (except in the regions of the servo wedges).

The drive 12 includes an actuator 51 of a known type, such as a voice coil motor (VCM). The actuator 51 can effect limited pivotal movement of a pivot 52. An actuator arm 53 has one end fixedly secured to the pivot 52, and extends radially outwardly from the pivot 52. The housing of the cartridge 16 has an opening in one side thereof. When the cartridge 16 is removably disposed within the drive 12, the arm 53 extends through the opening in the housing, and into the interior of the cartridge 16. At the outer end of the arm 53 is a suspension 56 of a known type, which supports a read/write head 57. In the disclosed embodiment, the head 57 is a component of a known type, which is commonly referred to as a giant magneto-resistive (GMR) head. However, it could alternatively be some other type of head, such as a magneto-resistive (MR) head.

During normal operation, the head 57 is disposed adjacent the magnetic surface on the disk 23, and pivotal movement of the arm 53 causes the head 57 to move approximately radially with respect to the disk 23, within a range which includes the innermost tracks 36 and the outermost tracks 37. When the disk 23 is rotating at a normal operational speed, the rotation of the disk induces the formation between the disk surface and the head 57 of an air cushion, which is commonly known as an air bearing. Consequently, the head 57 floats on the air bearing while reading and writing information to and from the disk, without direct physical contact with the disk. As stated above, the distance the head floats above the disk is known as the “fly-height.”

The drive 12 includes a control circuit 71, which is operationally coupled to the motor 21 in the cartridge 16, as shown diagrammatically at 72. The control circuit 71 selectively supplies power to the motor 21 and, when the motor 21 is receiving power, the motor 21 effects rotation of the disk 23. The control circuit 71 also provides control signals at 73 to the actuator 51, in order to control the pivotal position of the arm 53. At 74, the control circuit 71 receives an output signal from the head 57, which is commonly known as a channel signal. When the disk 23 is rotating, segments of servo information and data will alternately move past the head 57, and the channel signal at 74 will thus include alternating segments or bursts of servo information and data.

The control circuit 71 includes a channel circuit of a known type, which processes the channel signal received at 74. The channel circuit includes an automatic gain control (AGC) circuit, which is shown at 77. The AGC circuit 77 effect variation, in a known manner, of a gain factor that influences the amplitude of the channel signal 74. In particular, the AGC circuit uses a higher gain factor when the amplitude of the channel signal 74 is low, and uses a lower gain factor when the amplitude of the channel signal 74 is high. Consequently, the amplitude of the channel signal has less variation at the output of the AGC circuit 77 than at the input thereof.

The control circuit 71 also includes a processor 81 of a known type, as well as a read only memory (ROM) 82 and a random access memory (RAM) 83. The ROM 82 stores a program which is executed by the processor 81, and also stores data that does not change. The processor 81 uses the RAM 83 to store data or other information that changes dynamically during program execution.

The control circuit 71 of the drive 12 is coupled through a host interface 86 to a not-illustrated host computer. The host computer can send user data to the drive 12, which the drive 12 then stores on the disk 23 of the cartridge 16. The host computer can also request that the drive 12 read specified user data back from the disk 23, and the drive 12 then reads the specified user data and sends it to the host computer. In the disclosed embodiment, the host interface 86 conforms to an industry standard protocol which is commonly known as the Universal Serial Bus (USB) protocol, but could alternatively conform to any other suitable protocol, including but not limited to the IEEE 1394 protocol.

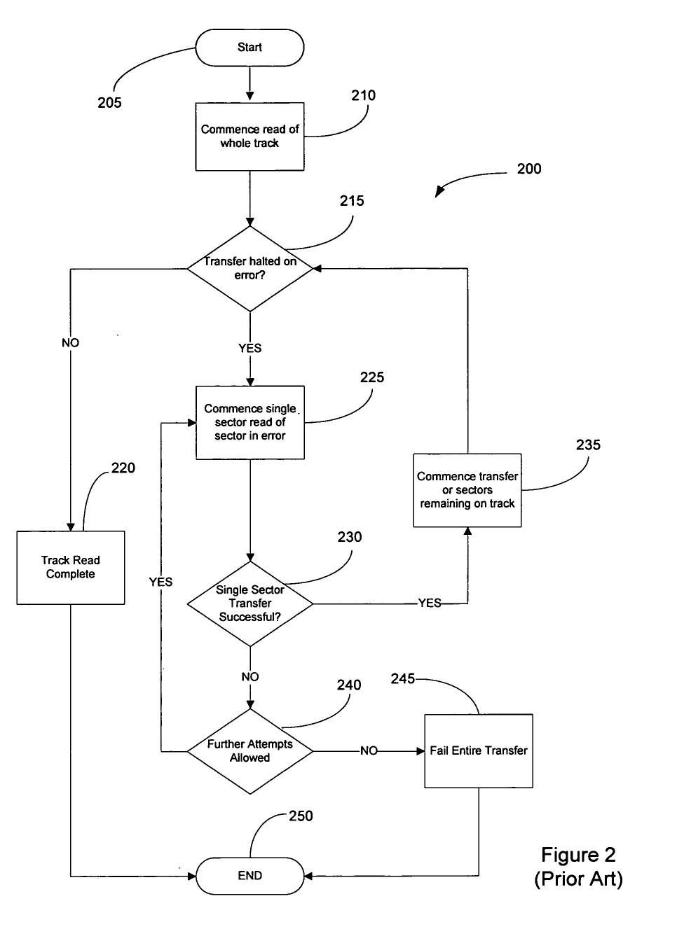

FIG. 2 is a flowchart showing the process 200 for error recovery currently used in prior art disk systems. The process 200 begins in START block 205. Proceeding to block 210, the process begins to read all sectors of a track on the disk drive. Data is read from the track until an error is detected.

Proceeding to block 215, the process 200 determines if a read error occurred during the data transfer from the track. If no errors are present on the track being read, the transfer will not stop due to an error and the process 200 proceeds along the NO branch to block 220. In block 220, the disk drive 12 completes the error free read of the entire track and then terminates the process 200 in END block 250.

Returning to block 215, if an error is detected during the reading of the track, the process 200 proceeds along the YES branch to block 225. In block 225, the disk drive begins to recover from the error by performing a single sector read of the sector in error. However, in order to perform this recovery, the disk must perform one revolution so the heads arrive over the data that needs to be re-read. This has an effect on the transfer rate as will be described below.

Proceeding to block 230, the process 200 determines if the single sector transfer was successful. If not and errors are still present, the process proceeds along the NO branch to block 240. In block 240, it is determined if the firmware of the disk drive allows further error recovery attempts. Each disk drive may allow a set number of attempts before aborting the read process. This number may be predetermined during calibration of the drive. If additional attempts to read the data are allowed, the process 200 proceeds along the YES branch back to block 225. If no additional attempts are allowed, the process 200 proceeds along the NO branch to block 245. In block 245, the entire transfer is failed for unrecoverable errors, then the process terminates in END block 250.

Returning to block 230, if the single sector transfer was successful, the process proceeds along the YES branch to block 235. In block 235, the process 200 continues the transfer of any sectors remaining on the track. This transfer continues unless an error is detected as indicated back in block 215. If further errors are detected, the error recovery process in blocks 225-240 is repeated. If no further errors are detected, the process completes the track read in block 220 then terminates. Because the error recovery process is performed for each bad sector one at a time, the process 200 has a negative effect on the transfer rate. This effect can be quantified in the following equation:

$$TransferRate = \frac{BytesPerTrack}{( 1 + ( AvgNumRetriesPerEr + 1 ) * NumSecInEr ) * TimePerRev}$$

After each retry one additional rev is required to restart the transfer which is the source of the addition of a one to AvgNumRetriesPerErr. This equation shows the transfer rate to be inversely proportional to the product of the NumSecInErr and the AvgNumRetriesPerErr.

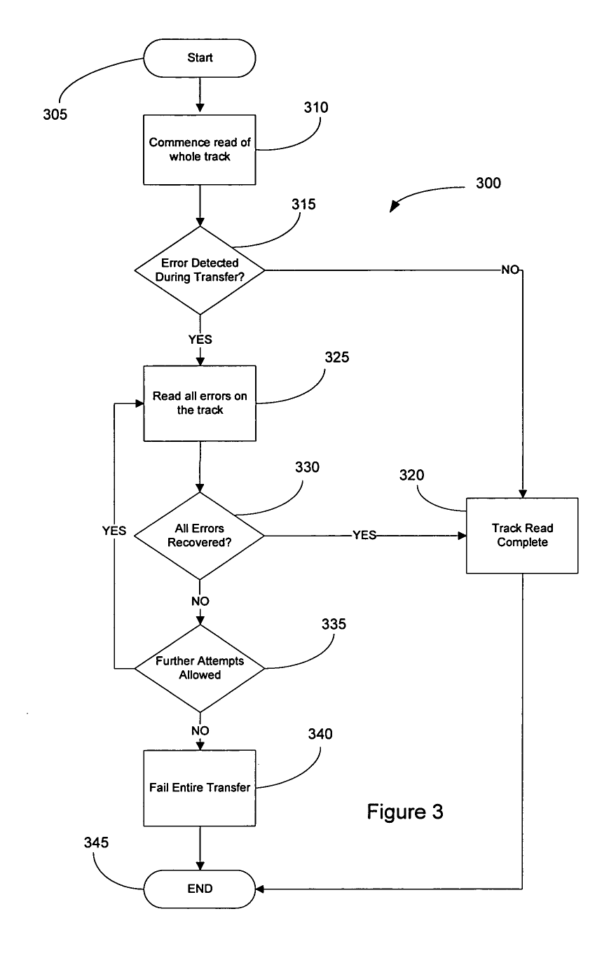

FIG. 3 is a flowchart showing the process 300 for error recovery used in one embodiment of the present invention. The process 300 begins in START block 305. Proceeding to block 310, the process begins to read all sectors of a track on the disk drive. Data is read from the track until an error is detected.

Proceeding to block 315, the process 300 determines if a read error occurred during the data transfer from the track. If no errors are present on the track being read, the transfer will not stop due to an error and the process 300 proceeds along the NO branch to block 320. In block 320, the disk drive 12 completes the error free read of the entire track and then terminates the process 300 in END block 345.

Returning to block 315, if an error is detected during the reading of the track, the process 300 proceeds along the YES branch to block 325. In block 325, the disk drive reads all errors on the track during a single read operation(in 1 retry revolution). Any sectors not containing errors may be recorded and the sector's data moved into a buffer. Thus, error recovery may be performed on all of the sectors in error simultaneously. This is different from the prior art system where error recovery of each sector was performed individually. This multiple sector retry method only incurs a transfer rate penalty equal to the number of revolutions required to recover the worst sector of the transfer.

Proceeding to block 330, the process 300 determines if all the errors on the track were recovered. If not and errors are still present, the process proceeds along the NO branch to block 335. In block 335, it is determined if the firmware of the disk drive allows further error recovery attempts. If additional attempts to read the data are allowed, the process 300 proceeds along the YES branch back to block 325. If no additional attempts are allowed, the process 300 proceeds along the NO branch to block 340. In block 340, the entire transfer is failed for unrecoverable errors, then the process terminates in END block 345.

Returning to block 330, if the multiple sector error recovery was successful, the process proceeds along the YES branch to block 320. In block 320, the process 300 completes the track read then terminates at END block 345.

The multiple sector error recovery process 300 effects the transfer rate as follows:

$$TransferRate = \frac{BytesPerTrack}{\begin{matrix}( 1 + NumberOfRetriesOfWorstError ) * \\ TimePerRevolution\end{matrix}}$$

Compared to the prior art technique, the multiple sector error recovery process does not require any extra revolutions when retries are invoked since no sectors are remaining following the retries. Thus, the multiple sector error recovery process will be more efficient than the prior art technique. The percent improvement of the multiple sector recovery method to the single sector recovery method can be described as:

$$\frac{MultipleSectorMethod}{SingleSectorMethod} = \frac{( 1 + ( AveNumRetriesPerError + 1 ) * NumberOfSectorInError )}{( 1 + NumberOfRetriesOfWorstError )}$$

This equation shows the ratio of improvement increases as the number of sectors in error increases and as the number of retries per error increases. Thus, the present invention allows for increased performance in error recovery of disk drives by a simple change to the firmware. No additional parts are required, thereby adding no additional cost to the drive.

Numerous variations and modifications of the invention will become readily apparent to those skilled in the art. Accordingly, the invention may be embodied in other specific forms without departing from its spirit or essential characteristics.

What is claimed is:

1. A method for error recovery in a disk drive comprising:
detecting an error during data transfer;
continuing the data transfer by reading multiple sectors in a track during a single read operation and identifying all sector errors in the multiple sectors; and
recovering the sector errors.

2. The method of claim 1, further comprising reading all the sectors in a track during a single revolution of the disk.

3. The method of claim 1, further comprising determining if further read operations are necessary to recover any sector errors.

4. The method of claim 3, further comprising re-reading multiple sectors in a track during a subsequent read operation to recover any additional sector errors.

5. The method of claim 1, further comprising failing the transfer if any errors are not recoverable.

6. The method of claim 1, further comprising completing the track read when all errors are recovered.

7. The method of claim 1, further comprising maintaining a record of what sectors moved to a buffer are in error.

8. A disk drive comprising:
a read head;
a data storage medium formatted into a plurality of data tracks; and
control circuitry which performs a data transfer between the read head and the data storage medium, wherein the control circuitry identifies multiple sector errors in a first of the plurality of data tracks during a single read operation and records the location of the errors.

9. The disk drive of claim 8, wherein the data read from the first of the plurality of tracks is moved to a buffer during the read operation.

10. The disk drive of claim 8, wherein the control circuitry recovers the errors.

11. The disk drive of claim 10, wherein the control circuit determines if further read operations are necessary to recover any additional sector errors and rereads the first of a plurality of tracks during a subsequent read operation to recover any additional sector errors.
